(19) United States
(12) Patent Application Publication
(10) Pub. No.: US 2008/0077795 A1
(43) Pub. Date: Mar. 27, 2008

(54) Method and apparatus for two-way authentication without nonces

(76) Inventor: David M. MacMillan, Mineral Point, WI (US)

Correspondence Address: David M. MacMillian, 2526 Weame Road, Mineral Point, WI, 53565, US

(21) Appl. No.: 11/903,812

(22) Filed: Sep. 25, 2007

Related U.S. Application Data
(60) Provisional application No. 60/846,981, filed on Sep. 25, 2006.

(51) Int. Cl. H04L 9/32; H04L 9/06; H04L 9/28

(52) U.S. Cl. 713/169; 380/44; 713/171

(57) ABSTRACT

A method and logical apparatus for accomplishing the two-way authentication of two parties without the use of nonce values. In the prior art, authentication may be accomplished both through the use of stored and of generated password lists. Also from the prior art these methods may be extended by the use of “nonce” values, a subset of a larger category of “anti-replay values” (ARVs). ARVs are values which satisfy the constraints that they must be used only once, that they must be unguessable by an attacker, and that they must reveal nothing about either the entity generating them or the entity receiving them. These methods are extended here by using not nonces but “Mutual Anti-Replay Values” (MARVs), which are values which satisfy the requirements for ARVs and which, further, are known to both the authenticator and authenticatee. These MARVs may be stored or generated lists independent of the password lists maintained by the authenticator and authenticatee, or they may be derived in special ways from these password lists. The use of MARVs in this invention, rather than the nonces of the prior art, provides tamper-evidence at the authenticatee while a replay attack is underway and provides security against serial impersonation attacks, in addition to protection against eavesdropping, protection against replay attacks, and tamper-evidence at the authenticator.

### CROSS-REFERENCE TO RELATED APPLICATIONS

This application claims the benefit of provisional patent application Ser. No. U.S. 60/846,981, entitled “METHOD AND APPARATUS FOR TWO-WAY AUTHENTICATION WITHOUT NONCES,” filed 2006 Sep. 25 by David M. MacMillan and Carl Ross.

### FEDERALLY SPONSORED RESEARCH

Not Applicable.

### Sequence Listing Or Program

Not Applicable.

### BACKGROUND OF INVENTION

1. Field of Invention

This invention relates to the secure authentication of entities or devices each to the other over untrusted communications media in adverse security conditions.

2. Definitions and Principles

What Authentication Is:

Given two entities or devices, A and B, B may be said to be “authenticated to A,” or A may “authenticate B” if and only if. A and B participate in some form of exchange such that A can be certain that B is in fact the true B and not a false B. In this authentication exchange, A plays the role of the “authenticator” (to whom B is authenticated) and B plays the role of the “authenticatee” (who is authenticated to A). Of course, these roles may be reversed and A may be authenticated to B. Certain circumstances demand two-way authentication where B is authenticated to A and A is authenticated to B. Other circumstances demand only one-way authentication. An authentication system capable of two-way authentication is always also, inherently, capable of one-way authentication (by simply ignoring, or in some systems or circumstances omitting, the second authentication). Schneier (1996) provides a good general overview of existing authentication principles, protocols, and technologies.

An assumption in the present discussion and systems is that an attacker wishing to subvert the authentication does not have access to the internal structure of A or B, except insofar as it may be deduced from external communications between them. The methods discussed here address protection against “within the protocol” (or more simply “in protocol”) attacks through the communication channel. They do not address “out of protocol” attacks which circumvent the channel (for example, attacks which involve physically disassembling A or B, attacks which involve gaining software-level access to A or B, attacks which involve some coercion of A or B, and so forth). In practice, of course, an implementation of the present systems may in addition implement arbitrary methods for protection against “out of protocol” attacks as a part of good engineering practice.

What Authentication is Not:

It is important to realize that authentication itself does not guarantee security or privacy. Consider a scenario where A and B are persons talking over the telephone, and A may or may not perform some action to be approved by B. For example, A might be a bank manager who may or may not open the bank vault depending on approval by B, a bank vice president. B may in fact be authentically B, but if an attacker has a gun to B's head (unknown to A), then the authentication of B does not guarantee the security of the actions of A.

Authentication of B to A simply requires that B become, authentically, involved; it may be contrasted with situations in which an attacker impersonates B.

Attacks Against Authentication: Eavesdropping:

A and B communicate over a communication channel, and it is assumed that an eavesdropper of arbitrary power and sophistication might be listening to this same channel. Authentication does not secure the channel against eavesdropping.

An authentication method (as distinct from the channel over which it operates) may be said to be secure against eavesdropping if an eavesdropper cannot extract or deduce from information on the channel during ordinary operation sufficient information to perform an attack against authentication in the future. Eavesdropping in itself is a passive form of attack which does not affect the validity of the current authentication.

Attacks Against Authentication: “Man in the Middle”:

A more powerful attacker may take active steps not only to eavesdrop on the communication channel but to alter communications on it. When the attacker severs the communications channel and impersonates B to A and A to B, this attack is termed in the literature a “man in the middle” attack. This form of attack can be very powerful (see Schneier (1996) p. 48-50 and 56).

A Man in the Middle attack may of course be repeated in subsequent authentications, but each repetition involves a new attack. In this way, repeated Man in the Middle attacks may be distinguished from “replay” attacks, discussed below.

Attacks Against Authentication: Replay:

A type of attack in which an attacker in some way isolates and interrogates either A or B, extracting sufficient information for one or more false authentications in the future, is termed a “replay” attack. (The attacker extracts information from A or B, and “replays” it to, appropriately, B or A.)

Attacks Against Two-Way Authentication:

Many authentication methods (indeed, most authentication methods in the present literature) provide one-way authentication only. That is, an authenticatee, B, is authenticated to an authenticator, A, but A is not authenticated to B.

Any one-way authentication method may be duplicated to provide two-way authentication. Such simple duplication of an authentication method is subject, however, to time-based attacks.

Consider the simple duplication of a one-way authentication method. In this duplication, B is first authenticated to A, and A is then authenticated to B. Even if these two authentication processes overlap in time, they are logically distinct operations which are therefore logically serializable. In notation:
A<-B(that is, B is authenticated to A)
A->B(that is, A is authenticated to B)

For example, B might be a bank customer and A might be a bank Automated Teller Machine (ATM). B authenticates to A, so that the bank is satisfied that this is indeed their authentic customer, B. Ideally (although this is not done in most contemporary ATM technology) A would then authenticate itself to B, so that the customer B is satisfied that this is indeed its authentic bank. Nevertheless, it is possible for both authentications to succeed and yet for the participants in the subsequent transactions to be false participants.

If these authentications are logically serial, it is possible for an attacker to allow B to authenticate to A, in the first step, and then to step in and impersonate B (perhaps through the physical removal of B). The second step of the authentication, authenticating A to B, is then meaningless (because the attacker simply ignores it).
A<-B

Attacker replaces B
A->B ignored

For example, I (as B) may authenticate myself to my bank's ATM (as A). A mugger may then incapacitate me and complete the transaction I have initiated. Even if the second stage of the authentication occurs (the ATM proves that it is, authentically, my bank's ATM), the mugger does not care.

Defenses Against this Type of Attack May Address Two Different Areas.

First, they may attempt to address the impersonation of B by the attacker. No prior art methods accomplish this, but the method of the present invention does.

Second, they may provide tamper evidence of the attack. Certain of the prior art methods may accomplish this, and the present invention does accomplish this.

This type of attack will be termed a “serial impersonation” attack against two-way authentication.

Types of Authentication Systems:

It is common in the literature of the field to distinguish three types of authentication systems: those based on what the authenticatee distinctively is, those based on what the authenticatee uniquely has, and those based on what the authenticatee knows. For example, authentication systems based on biometrics depend upon what the authenticatee is. Systems based on the use of a physical key, card, or other device depend upon what the authenticatee has. Systems based on passwords depend upon what the authenticatee knows.

I believe it useful to distinguish a fourth type of system: systems based upon what the authenticatee can do.

An example of this outside of the realm of computer science, but important in the history of secure communications, would be the use of Native American “code talkers” by the US military in the Second World War, and to a lesser extent in the First World War. Genuine Native American speakers exchanging messages in this program could in principle distinguish between genuine and impersonated communicators because only native speakers of their languages would possess authentically native accents. They could do something (speak their language with a true accent) that attackers could not.

(The case of authentication for the “code talkers” is a special case of the more general mechanism of the “shibboleth,” wherein authentication is provided by some linguistic act which the authentic entity can perform but which non-authentic entities cannot. This mechanism is known from and has had military applications since biblical antiquity (Judges 12:5-6). It is perhaps a sign of the general state of confusion of the field of computer security that in the literature of computer security this general term, “shibboleth,” is commonly misapplied so as to mean simply the first three types of systems (“what you are,” “what you have,” or “what you know”), which it is not, while the literature does not generally even distinguishing this fourth class (“what you can do”), of which the shibboleth it is one type.)

Within the field of computer science, public-key authentication schemes are of this type (see Schneier (1996) pp. 53-56, and Bellovin and Merritt (1994)). In these schemes, the act required of the authenticatee which can be performed only by the authenticatee is the encryption of a message, supplied by the authenticator, using the authenticatee's secret key. These schemes will be discussed further below.

These four classifications are of course simply useful heuristics for discussing systems. They are not based in any underlying mathematical or other formalism.

The invention to be discussed here is one of the very general class of systems which depends upon what the authenticatee knows. Additionally, I will distinguish it from systems of the other three types, and in particular from systems which depend upon what the authenticatee can do.

3. Prior Art

Authentication Method: The Single Password:

The simplest method of authentication is the single password. To authenticate B to A, both entities know, by prearrangement, a password. B sends this password to A, and if it matches, then A assumes that B is authentically B. The single password method dates to remote prehistory.

In situations where at least one of A or B are human, passwords commonly are words or phrases. In the general situation, however, a “password” may be any data. In many situations, “passwords” will be large random numbers.

In this simple form, password authentication is one-way (the fact that B authenticates against A does not imply that A is authenticated against B; if you as B know the password, you can present it to the wrong, or to a false, gatekeeper A, for example). To authenticate in both directions, the password protocol must be duplicated (with different passwords in the duplicated exchange).

Attacks on the Single Password Method:

This method of single passwords is subject to many attacks. An attacker may simply eavesdrop on the communication channel and intercept the password, which could then be used in the future to falsely authenticate the attacker. Here passive eavesdropping and active replay attacks are effectively equivalent. A more active attacker might stage a Man in the Middle attack. In this attack the attacker would first impersonate A to B. B would supply the password then not to A but to the attacker, who might then use it for false authentication, without even letting B access A. The fate of B in this scenario is undefined.

Out of Channel Defenses of the Single Password Method:

Many common defenses of password schemes are in fact “out of protocol” defenses, and thus not relevant here. Since they may often be confused with genuine “in protocol” defenses, a few of them will be reviewed.

For example, in a computer login situation it is common for the computer to store not the password itself but a one-way transformation of the password. This does not defend against the attacks noted above, but instead defends against an attacker's penetration of the computer (which is “out of protocol” in the present discussion). This method was introduced into the general literature by Evans, Kantrowitz and Weiss (1974), with references to earlier work by Purdy (1973), Wilkes (1972), and the MULTICS operating system.

It is also possible to encrypt the communications channel before the password is sent over it. This may be done in any of several ways, including using the SSH (Secure Shell) protocol (Ylonen and Lonvick 2006), the OpenSSH protocols (de Raadt et. al. (1999)), or by the TLS/SSL (Transport Layer Security, successor to the “Secure Sockets Layer”) protocols (Dierks 1999, 2006; Freier, Karlton, and Kocher 1996). While this method can be very effective in practice, it is also “out of protocol” in terms of the present discussion. An attacker who can penetrate or circumvent this encryption of the communications channel (for example, by keyboard sniffing on the authenticatee's keyboard or by compromising the password storage on the authenticator) is unhampered by this protection.

Other Deficiencies of the Single-Password Method:

Because the single-password method does not maintain any notion of state between authentication exchanges, it cannot detect, either at the authenticator or the authenticatee, attempts by an attacker to extract information for replay attacks. It does not therefore display “tamper-evidence” and neither the authenticator nor the authenticatee may be said to be “tamper-evident” in this sense.

Authentication Methods Stored One-Time Password Lists:

One solution to the problem of eavesdropping on passwords is simply never to re-use a password. This method also dates to remote prehistory.

The advantages of this method are obvious. An eavesdropper who acquires a password has, with this method, acquired useless information since the password so acquired will never again be used.

This method remains vulnerable to both a Man in the Middle attack (whereby an attacker does not simply eavesdrop on the password but actively intercepts it) and to replay attacks (whereby an attacker tricks the authenticatee into revealing one or more passwords to be used in the future).

This method also may provide tamper-evidence at the authenticator. In a situation where an attacker has begun a replay attack and extracted one or more passwords from the authenticatee, but has not used exactly this number of passwords against the authenticator, an attempted authentication by the authenticatee will fail. Further, the authenticator may be implemented so as to check the stored list of passwords to see if a future password from that list has been sent; if this is the case, an attempted replay attack may be presumed.

This method does not provide tamper-evidence at the authenticatee, since the authenticator never sends anything to it.

A best practice implementation of this method must use truly random passwords, or an eavesdropper may be able to draw conclusions about the method used for generating passwords. (In a human situation, for example, if passwords are simply common military phrases an eavesdropper could easily deduce this and generate false passwords with a high likelihood of success. In a machine situation, passwords generated by an algorithm may, in the case of flawed algorithms, allow the deduction of the algorithm from an examination of the generated passwords.)

Perhaps the conceptually simplest way to implement one-time password lists is simply to store the entire list of passwords. This introduces a potential implementation issue, because the size of this list may exceed the limits of the storage available.

This method was cited by Lamport (1981) as an alternative to his method of generated one-time password lists (see below).

Authentication Methods Generated One-Time Password Lists:

The system proposed by Lamport (1981) later codified into S/KEY (RFC 1760, 1995) also employs a list of one-time passwords. However, it avoids the implementation issue of storing a potentially large list of passwords by generating the password list in an exceedingly clever way such that it need not be stored.

Lamport's method relies on the concept of a “one-way function.” This is a mathematical function which, given an input, transforms that input into some output in such a way that it is computationally infeasible to deduce the input given only the output. To take a simple example, the function f(x)=2× is a two-way function, not a one-way function, because not only is it easy to compute the output given the input (y=2×), it is also easy to compute the input given the output (x=y/2). By way of contrast, the function f(x,y)=x*y, where x and y are large prime numbers, is to at least some extent one-way because it is easy to compute the output given the input (z=x*y), but at the present time it is computationally very difficult to factor large numbers into their prime factors. In general, many one-way functions are discussed in the literature; they are an essential component of modern cryptography. See Schneier (1996), p. 29 for a very brief introduction. Lamport's method may be used with any appropriate one-way function; it does not depend upon a particular function.

If additionally a one-way function provides an output which is much smaller than the input, it is termed a “hash” function. Hash functions are commonplace in field of computer science, and cryptographically good hash functions are an important part of the literature of cryptography. See Scheier (1996), in various sections throughout, for introductory discussions. The one-way functions used in Lamport's methods may also be, but need not also be, hash functions.

If additionally a one-way function adds some secret information to its computation, it is termed a Message Authentication Code (MAC). See Scheier (1996) p. 31. The purpose of adding this information is to restrict the ability to compute the function to only those entities in possession of this additional secret information. The one-way functions used in Lamport's method are not MACs.

Public Key Cryptographic algorithms are special cases of one-way functions in which the function is in intent one-way for all parties except the recipient (who possesses special additional information which renders the function two-way). Public Key Cryptographic algorithms may be used as “ordinary” one-way functions if this secret information is either kept secret or destroyed.

Lamport's method starts with a single piece of information, a secret key k known only to the authenticatee. (In the present discussion, the terms “key” and “password” will be taken to be synonymous.) Given an adequately good one-way function, it is in theory possible to construct any number of keys from this single key by the repeated application of the function. Thus, given one-way function OW( ), the first key is k, the second key is OW(k), the third key is OW(OW(k)), and so forth up to some maximum number of iterations, n. Each key may be notated “kᵢ” where 0<=i<=n. The result of this process is a potentially virtual list of keys.

Given any key kᵢ, it is easy to compute the next key value kᵢ₊₁, by applying the one-way function: kᵢ₊₁=OW(kᵢ). If the one-way function is adequate, however, it is computationally infeasible to compute the previous key value, kᵢ₋₁. The authenticatee, therefore, who has k, may easily compute any password kᵢ. without storing the entire list of passwords. (The authenticatee may also trade off computation time and storage space by precomputing various intermediate passwords at fixed or variable intervals and computing new passwords iteratively from these stored intermediate values.)

Lamport's method depends upon the ease of “forward” computation of passwords and the difficulty of “backward” computation, and proceeds by going backwards through the list. Initially, the authenticatee and authenticator agree upon some maximum number of password iterations, n. The authenticatee generates k (best practice would employ a truly random large number) and, further, generates the password kₙ, by iterating through the password list and repeatedly applying the one-way function. The final step of the setup is the communication of this password kₙ to the authenticator by some reliable, secure method. In this way, both the authenticator and authenticatee know n, but only the authenticatee knows k. The authenticator knows only kₙ.

Call the authenticator A and the authenticatee B. Having set up this system, if B wishes to authenticate itself to A, B computes kₙ₋₁. B then sends this value to A as its password. A computes OW(kₙ₋₁), which of course should be equal to kₙ, which it knows. If it is so equal, then authentication succeeds, otherwise authentication fails.

If authentication succeeds, A discards kₙ and retains kₙ₋₁ as its new authenticating value. A and B both decrement their n by 1. In the next authentication, B computes kₙ₋₂ as its password, and A checks this against kₙ₋₁ by applying the one-way function. This process can continue until n decrements past zero.

Lamport's method is secure against eavesdropping because a password observed by an eavesdropping attacker will never be used again.

Lamport's method is not secure against a Man in the Middle attack, however. Such an attack is very simple: the attacker simply severs the communications link between B and A, then listens on it for B to send the current password, and finally presents that password to A, thus falsely authenticating itself as B. Such an attack may go completely undetected if B assumes that the authentication session failed due to other circumstances (for example, ordinary network problems). In particular, after such an attack both A and B maintain their values of i (the index of the current authentication exchange) synchronized with each other, so further valid authentications may occur even though authentication has in this instance been compromised.

Lamport's method is also not secure against replay attacks. In such an attack, the attacker impersonates A to B one or more times, storing the passwords sent to it by B for later use against A. This attack may or may not be detectable (that is, this method may or may not provide tamper-evidence at the authenticator). If, before B attempts a valid authentication, the attacker authenticates against A exactly the number of times for which it has passwords, then this attack is not detectable (because A and B will each have the same n at the end of the attack sequence). If the attacker does not authenticate for exactly the number of times for which it has passwords before B attempts a valid authentication, then this attack may be detected.

Lamport's method also involves a restriction to a finite number of passwords, n, after which the authentication system becomes useless. Practical limits for n are tied to the time taken for n iterations of the one-way function. In the past this was a significant practical disadvantage, but as computing power increases it is less of a disadvantage.

Lamport's method suffers from a disadvantage when compared to Stored One-Time Password Lists in that it is highly dependent upon the quality of the one-way function. At the present time, no proof is known for the inherent one-way-ness of any one-way function. Flaws have been discovered in the past for one-way functions once thought to be adequate. Moreover, analysis of one-way functions is an ongoing, important part of research in cryptography. If a flaw is discovered in the one-way function used in an implementation of Lamport's method, the method may in that implementation fail.

As with simple passwords, one-time password list authentication is one-way; it must be duplicated for two-way authentication.

Authentication Methods Public-Key Methods:

The methods discussed above (Simple Password, Stored One-Time Password List, and Generated One-Time Password List) depend upon something that the authenticatee knows: the password. “Public Key” authentication methods depend instead upon something that the authenticatee can do.

In cryptography in general, a plaintext message Mₚ is encrypted using an encryption function E and an encryption key K to produce an encrypted message (a “ciphertext”) Mₑ. This is notated as: Mₑ=E(Kₑ,Mₚ) Decryption occurs using a decryption function D, and a decryption key K_{d}. This is notated as: Mₚ=E(K_{d},Mₑ)

In traditional or “symmetric” cryptography, Kₑ=K_{d}, which is to say that the encryption and decryption keys are the same. In “public key” cryptography, these keys are different, and are related in such a way that a knowledge of the encryption key does not allow the decryption key to be deduced. The encryption key may thus be made public, and anyone may encrypt messages using it. Only the possessor of the decryption key, however, will be able to decrypt these messages and recover the plaintext.

In the public key cryptographic systems in use today, both the public key and the private key can be used as encryption or as decryption keys. That is, a message may be encrypted using the public key and decrypted using the private key, or encrypted using the private key and decrypted using the public key. See Garrett (2001) p. 159.

See Schneier (1996), Garrett (2001), or any modern cryptographic textbook for a general explanation of public key cryptography. The seminal paper was Diffie and Hellmann (1976), although earlier work had been done by Merkle and, covertly, in the intelligence communities.

To use public key cryptographic technology to perform authentication, the authenticatee B would generate a public/private keypair. The public key could be made public, of course, and be known to the authenticator, A. In the simplest authentication exchange. A would send a random message to B. B would encrypt this message using B's private key and send the encrypted message back to A. A would decrypt this message using the public key and compare it to the original message. Since only B knows B's private key, and since only B's private key can generate a message which will decrypt to the original message using the public key, B is therefore assumed to be in fact, B.

This method is not vulnerable to eavesdropping, since in each exchange the message is different.

This method is vulnerable to a Man in the Middle attack. An attacker who has severed the communications between A and B may impersonate B to A, thus gaining knowledge of the original message. The attacker then impersonates A to B, presenting this original message to B and receiving B's encryption of it. Finally, the attacker again impersonates B to A, passing to A the (correct) encrypted message and thus gaining false authentication.

One attempt to defend this type of authentication against a Man in the Middle attack is a proposal by Davies and Price (1989) to apply the “Interlock Protocol” of Rivest and Shamir (1984). This defense was shown to be inadequate by Bellovin and Merritt (1994).

In this simple implementation this method is also vulnerable to chosen-plaintext attacks against B. Since B simply encrypts the message and returns it, an attacker could supply B with chosen plaintexts and cryptographically analyze the results. As public key algorithms are vulnerable to chosen-plaintext attacks (Schneier (1996) p. 33) this type of attack is important. Schneier (1996) p. 54 illustrates a method which defends against chosen-plaintext attacks on this method.

Although this method is vulnerable to Man in the Middle attacks, it is not vulnerable to replay attacks. In each authentication exchange, the authenticator A sends a different and not a priori knowable message to B. An attacker would have no way of generating these messages so as to prompt B to generate passwords to replay.

This method does not provide any sort of “tamper-evidence” for either the authenticator or the authenticatee because it is stateless between authentication exchanges. In this way, it resembles the simple password method (which is similarly stateless) and differs from both the stored and the generated password list methods (which are stateful).

The authentication methods of the present invention do not rely on public key or other “what you can do” methods of authentication. However, they do share with the public key methods their lack of vulnerability against eavesdropping attacks and against replay attacks.

Authentication Method: the Simple Password and a Nonce:

In a modification of the Simple Password method, described above, the authenticator A may first generate a “nonce” value and send it to the authenticatee B. B then combines this nonce with the password, computes a one-way function based on this combination, and sends the result back to A. Since A knows both the nonce and the password, A can perform the same computation to check the value returned.

The full characteristics of “nonce” and related values will be discussed below. Here a “nonce” value may be taken to be any value not guessable by an attacker. (By implication, it must therefore only be used a single time, hence its name.) A good nonce value would be a truly random number, but other types of nonces may and have been used. Franks et. al. (1999) discusses methods and criteria for the selection of nonces in the context of their use in a different system than the one discussed here.

The use of a “nonce” value may be traced at least to Needham and Schroeder (1978) and may predate that.

The use of a nonce in this way addresses two separate attack issues: eavesdropping and replay.

This method is secure against eavesdropping because the value sent by B to A will in each instance be different, and be based in part on information unknown to the attacker (that is, upon the password itself, which is never itself exchanged between B and A). The nonce value need not be kept secret, because it will never be used again and because it is combined with information unknown to the attacker.

This method is secure against a simple “replay” attack where the attacker attempts to gain the password from B for future use, because the attacker cannot know the future nonce values to be used by A.

However, this method is not secure against a simple “man in the middle” attack whereby the attacker intercepts the nonce value, sends it on to B, and then intercepts the returned value.

Neither does this method does not provide tamper-evidence in the case of attempted replay attacks, as there is only a single password.

This use of nonces may not be secure against attacks in which the attacker has greater cryptographic sophistication. The security of this method depends upon the security of the one-way transformation of the nonce and the password. There are many one-way functions, and the formulation of attacks and potential attacks on them is an important part of cryptographic research. If for the function used an attack is determined, then this method fails. The chances of the success of such an attack increase significantly when an attacker can present a chosen “known plaintext” in place of the nonce as used here. Thus, an attacker who knows how to attack the one-way hash algorithm and who has access to B can, through the use of false nonces, extract from B the password.

As with previously mentioned methods, the “single password and nonce” approach is one-way and must be duplicated for two-way authentication.

This concludes an initial survey of the terminology of the field and of the prior art in the field sufficient to understand the present invention. The discussions to follow generalize upon this prior art and describe the present invention.

### SUMMARY

A method and its apparatus are presented for accomplishing the two-way authentication of two parties, A and B, to each other without the use of nonces, which is secure against eavesdropping, which provides tamper-awareness at both the authenticator and authenticatee against attempted replay attacks, which is secure against replay attacks, and which is secure against serial impersonation attacks.

### DRAWINGS

### Figures

None.

### DRAWINGS

### Reference Numerals

None.

### DETAILED DESCRIPTION

### Preferred Embodiment

The description of the present invention, which invention does not involve the use of nonces, is best understood after a preliminary discussion of the extension of the password list methods of the prior art through the application of nonces to them.

Authentication Method Stored One-Time Password List and Nonces:

The use of nonce values with single passwords, described above, may be generalized to the use of nonce values with Stored One-Time Password Lists. In this extensions, in each authentication exchange the authenticator A first generates a nonce value and sends it to the authenticatee B. B combines this value with the stored or generated password, in any way which preserves all of the information of both, applies a one-way function to the combination, and sends the result back to A. The authenticator A knows both the nonce value and the expected password, and so can perform the same computation. If the results of the two computations match, then B is considered to be authenticated.

This method is not vulnerable to eavesdropping, since the use of a nonce value means that B never transmits the same value back to A.

This method is not vulnerable to replay attacks, since (by the definition of a nonce) the nonce value for any authentication exchange is not guessable by an attacker.

This method is vulnerable to a Man in the Middle attack. In such an attack, an attacker would first impersonate B to A, securing the current nonce value. The attacker would then impersonate A to B, providing this nonce value and receiving the (correct) return value. Finally, the attacker would again impersonate B to A, supplying this value and achieving a false authentication.

As with the simple Stored One-Time Password List method this nonce-extension may be implemented so as to provide tamper-evidence at the authenticator in the event of a replay attack followed by a legitimate authentication attempt.

As with previously mentioned methods, this method is one-way and must be (and may easily be) duplicated for two-way authentication (this will be discussed in greater detail later).

It will be useful in further discussions to summarize here what each entity, A and B, must maintain in this authentication method.

A, the authenticator, must maintain:

1. k, the list of keys (passwords).
2. i, an index into this list, whose value is effectively the serial number of the current authentication exchange.
3. The ability to generate nonce values Q as necessary.
4. The ability to apply a one-way function, OW( ), as necessary.
   B, the authenticatee, must maintain:
1. k, the same list of passwords
2. i, an index into this list, whose value should increment in parallel to the i maintained by A, unless a replay attack has been attempted.
3. The ability to apply a one-way function, OW( ), as necessary.

The method used to generate nonce values need not be secret, but of course the nonce values it generates cannot be predictable.

The one-way function OW( ) need not be secret.

Authentication Method Generated One-Time Password Lists and Nonces:

The extension of Lamport's method of Generated One-Time Password Lists so as to use nonces is more complex. The authenticator A may generate a nonce value and send it to B, as above, and B may combine this value with the current password, apply a one-way function to it, and return it to A. The problem occurs when A attempts to verify the value so returned. In Lamport's method, A does not in fact know the current password, kᵢ, but instead knows only the “next” password in the iterative sequence, kᵢ₊₁. In order to calculate kᵢ₊₁ from the value returned from B, A must have kᵢ. But kᵢ has been combined with the nonce value and the combination has had a one-way function applied to it. A cannot extract kᵢ to complete the authentication unless A can reverse the one-way function applied to the combination of kᵢ and the nonce.

The solution to this problem is for B to employ not an arbitrary one-way function, but rather to employ a function that A, and only A, can reverse. Public-Key Cryptography provides a way to do this. At some prior point in time, A generates a public/private keypair using any appropriate public-key cryptographic technology. A makes its public key known to B (and indeed need not keep this key secret from other parties). In the authentication exchange, A then proceeds as above by generating a nonce value and sending it to B. B combines this nonce value, as above, with the current password as generated by Lamport's method. B then encrypts this combined value using A's public key and transmits the encrypted value to A. Basically, B is simply using conventional public-key cryptography to send its nonce/password combination back to A. Note that this is simply a use of public key cryptography for message transmission. It is not an application of public key cryptography to authentication in the sense described earlier. Indeed, it is the opposite. In the application of public key cryptography to authentication described earlier, B uses its private key to perform a function that only it can perform (encryption using that private key). In this present use of public key cryptography together with a generated password list and nonce values, B uses A's public key to encrypt a message sent to A, which is an action that anyone could perform.

This method has some of the same advantages and disadvantages relative to Stored One-Time Password Lists with Nonces as Lamport's method (without nonces) has relative to Stored One-Time Password Lists (without nonces). It economizes on space, as complete password lists need not be stored, but in exchange it requires additional computation as passwords must be generated. It is also subject to weaknesses in the one-way functions, should such weaknesses be discovered.

This method is not vulnerable to eavesdropping, as the use of nonce values means that the same value will never be transmitted twice from B to A.

This method is vulnerable to Man in the Middle attacks in the same way as Stored One-Time Password Lists with Nonces.

This method is not vulnerable to Replay attacks, as the attacker cannot know in advance the nonce values which will be used.

As with the Stored One-Time Password List methods (with or without nonces), and the simple Generated One-Time Password List method, this nonce-extension may be implemented so as to provide tamper-evidence at the authenticator in the event of a replay attack followed by a legitimate authentication attempt.

This method may be vulnerable to known-plaintext attacks against the public-key encryption algorithm used by B.

As with previously mentioned methods, this method is one-way and must be (and may easily be) duplicated for two-way authentication (this will be discussed in greater detail later).

It will be useful in further discussions to summarize here what each entity, A and B, must maintain in this authentication method.

A, the authenticator, must maintain:

1. kᵢ₊₁, the (i+1)^{th} password
2. Its private and public cryptographic keys (PKA_{pub}, PKAₚᵣᵢᵥ)
3. The ability to generate nonce values Q as necessary.
4. The ability to apply public key decryption function D(PKAₚᵣᵢᵥ, C), as necessary.
5. The ability to decompose the combined nonce value and password.
6. The ability to apply a one-way function OW( ).
   B, the authenticatee, must maintain:
1. k, the initial password, or its equivalent
2. i, an index into the password list, which is effectively also a serial number for the current authentication exchange.
3. The ability to apply a one-way function OW( ) repeatedly to generate the key (password) list.
4. The ability to apply a function C(Q,kᵢ) to compose a combination of the nonce value and the current key, as necessary.
5. The ability to apply a public key encryption function E(PKA_{pub}, C)

The method used to generate nonce values need not be secret, but of course the nonce values it generates cannot be predictable.

The one-way function OW( ) need not be secret.

The method used to combine the nonce value and the key need not be secret.

The public key cryptographic algorithms D( ) and E( ) need not be secret.

Authentication Method Two-Way Authentication using Stored One-Time Password Lists and Nonces

Consider duplicating the approach of Stored One-Time Password Lists with Nonces, as described above, such that A authenticates B and, in duplicate, B authenticates A. Although in itself this is a trivial duplication of the method, it will be useful in the discussion of this invention to identify clearly the information present in this method.

A, as both authenticator and authenticatee, must maintain:

1. kb, the list of keys (passwords) for B; different than ka.
2. ka, the list of keys (passwords) for A; different than kb.
3. i, an index into these lists, whose value is effectively the serial number of the current authentication exchange.
4. The ability to generate nonce values Q as necessary.
5. The ability to apply a one-way function, OW( ), as necessary.
   B, as both authenticator and authenticatee, must maintain:
1. ka, the same list of keys (passwords) for A; different than kb.
2. kb, the same list of keys (passwords) for B; different than ka.
3. i, an index into these lists, whose value should increment in parallel to the i maintained by A, unless a replay attack has been attempted.
4. The ability to generate nonce values Q as necessary.
5. The ability to apply a one-way function, OW( ), as necessary.

The method used to generate nonce values need not be secret, but of course the nonce values it generates cannot be predictable.

The one-way function OW( ) need not be secret.

Each direction of authentication must have its own password list, and these lists should be independent of each other. Both A and B must maintain both lists. Both A and B must also possess the ability to generate nonce values Q.

This step is a change in the prior art insofar as it extends it with the use of One-Time Password Lists together with Nonces (as does the method described in the previous section), and insofar as it duplicates this system for two-way authentication.

Since it is a simple duplication of “One-Time Password Lists and Nonces,” its security is the same as that method.

With regard to “serial impersonation” attacks against two-way authentication, where an attacker impersonates the authenticatee after the first “way” of the two-way authentication process, it can provide tamper-evidence of this attack if in the future another legitimate authentication is attempted. If this attack occurs, the next time a legitimate authentication is attempted the positions of the authenticator and authenticatee in the password list for the second “way” of the authentication will differ.

This method cannot, however, provide for the detection of this type of attack as it occurs.

Authentication Method Two-Way Authentication Using Generated One-Time Password Lists and Nonces

Consider duplicating the approach of Generated One-Time Password Lists with Nonces, as described above, such that A authenticates B and, in duplicate, B authenticates A. Although in itself this is a trivial duplication of the method, it will be useful in the discussion of this invention to identify clearly the information present in this method.

A, as both authenticator and authenticatee, must maintain:

1. kbᵢ₊₁, the (i+1)^{th} password for B
2. ka, the initial password for A, or its equivalent
3. Its private and public cryptographic keys (PKA_{pub}, PKAₚᵣᵢᵥ)
4. The ability to generate nonce values Q as necessary.
5. i, an index into the password list, which is effectively also a serial number for the current authentication exchange.
6. The ability to apply a one-way function OW( ) repeatedly to generate the key (password) list (for A).
7. The ability to apply a function C(Q,kaᵢ) to compose a combination of the nonce value and the current key, as necessary.
8. The ability to apply a public key encryption function E(PKA_{pub}, C)
9. The ability to apply public key decryption function D(PKAₚᵣᵢᵥ, C), as necessary.
10. The ability to decompose the combined nonce value and password.
11. The ability to apply a one-way function OW( ).
   B, as both-authenticator and authenticatee, must maintain:
1. kb, the initial password for B, or its equivalent
2. kaᵢ₊₁, the (i+1)^{th} password for A
3. Its private and public cryptographic keys (PKB_{pub}, PKBₚᵣᵢᵥ)
4. The ability to generate nonce values Q as necessary.
5. i, an index into the password list, which is effectively also a serial number for the current authentication exchange.

6. The ability to apply a one-way function OW( ) repeatedly to generate the key (password) list (for B).
7. The ability to apply a function C(Q,kbᵢ) to compose a combination of the nonce value and the current key, as necessary.
8. The ability to apply a public key encryption function E(PKA_{pub}, C)
9. The ability to apply public key decryption function D(PKAₚᵣᵢᵥ, C), as necessary.
10. The ability to decompose the combined nonce value and password.
11. The ability to apply a one-way function OW( ).

The method used to generate nonce values need not be secret, but of course the nonce values it generates cannot be predictable.

The one-way function OW( ) need not be secret.

The method used to combine the nonce value and the key need not be secret.

The public key cryptographic algorithms D( ) and E( ) need not be secret.

This step is a change in the prior art insofar as it extends it with the use of One-Time Password Lists together with Nonces (as does the method described in the previous section), and insofar as it duplicates this system for two-way authentication.

Since it is a simple duplication of “One-Time Password Lists and Nonces,” its security is the same as that method.

With regard to “serial impersonation” attacks against two-way authentication, it provides the same capabilities, for the same reasons, as the method of Two-Way Authentication Using Stored One-Time Password Lists with Nonces.

Two-Way Authentication Using Stored One-Time Password Lists without Nonces

Assertion of Novelty

The approach described above as “Two-Way Authentication using Stored One-Time Password Lists with Nonces” may be modified in a novel and far from obvious way so as to eliminate one aspect of the prior art, the use of nonce values.

Summary of Advantages

This new approach provides all of the advantages of all of the prior art methods noted, and their extensions as noted here, including combinations of advantages not present in any single prior art method. For example, it provides not only
1. Tamper-evidence at the authenticator in the event of future legitimate authentication attempts (as the Stored or Generated One-Time Password List without Nonces methods do), but also provides, simultaneously,
2. Security against replay attacks (as Nonce methods do).
   This new approach also provides at least four advantages not present in the prior art:
1. Tamper-evidence at the athenticatee (vs. the authenticator) during a replay attack,
2. Independence of flaws which may be discovered in the apparatus embedded in A and/or B for generating nonce values, and
3. Security against known-plaintext-nonce attacks.
4. Security against (and tamper-evidence of) “serial impersonation” attacks against two-way authentication methods.
   Requirements for an Anti-Replay Value

The various “nonce” methods of the prior art depend upon the use of a value sent from the authenticator to the authenticatee. The function of this value is to protect against replay attacks by causing the authentication exchange to be different each time it occurs. Values to accomplish this goal may indeed be nonce values, as in the prior art. however, in general nonce values are but a subset of a more general set of values which satisfy this goal. This more general set of values will be called here the set of “Anti-Replay Values” (“ARVs”).

An Anti-Replay Value (“ARV”) must satisfy the following requirements:

1) It may not be used more than once.

2) It must be unguessable by an attacker.

3) It must reveal nothing about the secret contents of the entity generating it.

4) It must reveal nothing about the secret contents of the entity receiving it.

While these requirements are satisfied by the use of a nonce value, they may also be satisfied by other values which are not “nonce” values.

In particular, one other subset of the general set of ARVs is the subset of values known both to the authenticator and to the autheriticatee. Values in this subset will be termed here “Mutual Anti-Replay Values” (“MARVs”) because they are known to both (that is, known mutually by both) the authenticator and authenticatee.

MARVs have significant advantages over nonces because they are mutually known. If an authenticator sends a nonce to an authenticatee, the authenticatee has no way of knowing if the value received did indeed come from the authenticator. It may therefore execute actions in response to this value which may render it liable to compromise. If by way of contrast the authenticatee (but not the attacker, of course) knows what value to expect, and it receives a values other than expected, it may detect this suspicious situation and react appropriately. MARVs thus provide tamper-evidence during replay attacks in a way that nonces cannot.

For password-list authentication methods, MARVs may be constructed in either of the ways in which password lists themselves may be constructed. For example, MARVs may be constructed as two mutually known lists of stored, precomputed values (which themselves are perhaps random numbers). MARVs may also be constructed as generated lists using Lamport's method; the special requirements for generating MARVs from Lamport-style generated lists will be discussed in the “Two-Way Authentication Using Generated Password Lists without Nonces” section, below.

The MARVs used in an authentication protocol need not be constructed using the same methods as the password lists (for example, an entity's password list might be a stored list, while its MARV list might be a generated list, or vice versa). The MARVs used in a two-way authentication protocol need not be constructed using the same methods in either “way” or direction of authentication; one direction might use stored-list MARVs, while the other might use generated-list MARVs.

If implemented independently of the password lists, the use of MARVs as opposed to nonces imposes an additional storage requirement (especially for stored-list MARVs) and possibly an additional computational requirement (especially for generated-list MARVs). However, it is possible to construct MARVs using the existing password lists of entities in such a way that no separate storage is required for them and only a potentially modest computational overhead is imposed. This is because these lists already satisfy most of the requirements of MARVs. They consist of elements which are known mutually, which are used only once, and which are not guessable by an attacker. All that remains to use password list values as MARVs is to ensure that their use for MARVs reveals nothing about the password lists themselves.

For authentication using stored password lists, the application of a one-way function, here called “OWM( )” to distinguish it from other one-way functions, to the current password for B satisfies these qualities for the generation of a MARV, Ma, for A, while the application of a one-way function OWM( ) to the current password for A satisfies these qualities for the generation of an anti-replay value Mb for B. These may be represented in notation as:
Ma=OWM(kbᵢ)
Mb=OWM(kaᵢ)

That this is so may be seen by examining the requirements for an anti-replay value. Because each of these values, Ma=OWM(kbᵢ) and Mb=OWM(kaᵢ) are based on the current item in the password lists ka and kb, they are different for each authentication exchange and thus satisfy the first criterion for an ARV (they are never used more than once). Because they depend upon the contents of these password lists, which are kept secret and should be generated in such a way as not to be guessable by an attacker, they are themselves not guessable by an attacker and thus satisfy the second criterion for an ARV. Finally, because they are generated by the application of a one-way function to the password from the list ka or kb, they do not reveal the contents of the password lists ka or kb, and thus satisfy the third and fourth criteria for an ARV.

These values, Ma=OWM(kbᵢ) and Mb=OWM(kaᵢ) are ARVs (and indeed MARVs), but they are not “nonce” values because they are functionally related to the password lists ka and kb. By way of illustrative contrast, for example, a random number (which is a nonce value) could not function in the way in which these values function in this present invention, nor could a random number nonce value provide all of the advantages provided by this present invention.

The function OWM( ) as used by one entity may in practice be the same as the function OWM( ) as used by the other entity, or it may be different. All that is required is that both entities implement, and use as appropriate in the protocol, the function OWM( ) used by the other entity.

The protocol and operation of this method will be discussed later in the “OPERATION” section.

Two-Way Authentication Using Generated One-Time Password Lists Without Nonces

Assertion of Novelty

The approach described above as “Two-Way Authentication using Generated One-Time Password Lists with Nonces” may be modified in a novel and far from obvious way so as to eliminate one aspect of the prior art, the use of nonce values.

Summary of Advantages

This new approach provides all of the advantages of the method of Two-Way Authentication Using Stored One-Time Password Lists Without Nonces, as described in the previous section.

Requirements for MARVs

This new approach uses Mutual Anti-Replay Values (MARVs) as described in the previous section.

Selection of the MARVs

MARVs for use in this approach may be implemented independently of the password lists, using stored lists of MARVs, as presented earlier. Additionally, MARVs for use in both this approach and the Stored Password List approach may be created from Lamport-style generated lists. The generated lists so used may be either independently maintained generated lists or the generated password lists of the entities themselves.

In the method described in the previous section, an authenticator, A, generated a Mutual Anti-Replay Value (MARV), Ma, by either of two methods: either it selected a value from a stored list of MARVs maintained by both the authenticator and authenticatee, or it applied a one-way function OWM( ) to the current key (password) in the authenticatee's password (key) list, a list stored by both the authenticator and the authenticatee. Neither of these approaches is possible if the MARVs are to be based on Lamport-style generated lists (either a separate list or the authenticatee's password list) as the authenticator does not in fact know the current value in this list. The authenticator knows only the one-way transformation of this value. For example, for a generated list based on the authenticatee's password list, kb, the authenticator does not at any given point know, kbᵢ, but knows only the transformation of it into kbiᵢ₊₁, by the application of the one-way key list generation function, here designated “OWG( ),” such that kbᵢ₊₁=OWG(kᵢ).

Simply using kbᵢ₊₁ (or its equivalent in a separately generated list) as MARV Ma is not advisable, because this reveals information which should be known only to the authenticator, and which could be used in constructing a replay attack against the authenticator. Similarly, it is not advisable to use the one-way transformation of this value if the same one-way function, OWG( ), is used as is used to generate the list, because this transformation simply generates further values in the list which might be used for more sophisticated replay attacks which also tampered with the perceived sequence of authentication events.

However, the use of a different one-way function, unrelated to the list-generating function OWG( ), to transform kbᵢ₊₁ does not suffer from these disadvantages. This function will be notated here as OWM( ).

In this method, then, for a list kb (either a password list or a separate list) the first entity acting in its role as the authenticator constructs OWM(kbᵢ₊₁) as its MARV Ma. Similarly, the other entity when acting in its role as authenticator constructs Mb OWM(kaᵢ₊₁).

As with the previous method, the two one-way functions OWM( ) as used by each entity may be identical or different, so long as each implements both and uses them appropriately in the protocol. Further, as with any two-way authentication method using Lamport-style generated password lists, the key generating functions OWG( ) used by each entity may also be identical to each other or different, again so long as both entities implement both and use them appropriately in the protocol. However, no OWM( ) may be identical to OWG( ) in the same “way” of the authentication.

The protocol and operation of this method will be discussed later in the “OPERATION” section.

### Operation

### Preferred Embodiment

Two-Way Authentication Using Stored One-Time Password Lists Without Nonces

The information maintained by A and B in this method is the same as the information maintained in the “Two-Way Authentication Using Stored One-Time Password Lists with Nonces” with the following exceptions:
1. Neither A nor B need contain the capability of generating nonce values.
2. If A and/or B use MARVs from lists separate from their password lists, then both A and B must store each MARV lists so used. In this case A and B will also use a one-way function in generating return values; this function, OWR( ), is the same as the function OWR( ) described in the next item.
3. If A and/or B use MARVs constructed from their password lists, then they need not maintain separate MARV lists. However, in this case both A and B use one-way functions in two roles. One of these roles will be performed by functions designated OWM( ), as discussed above, and will be used to produce MARVs securely from a stored password list. The other of these roles will be performed by functions designated. OWR( ), and will be used in the return of values from the authenticatee to the authenticator. As discussed above, OWM( ) may be identical or different in each of the two entities A and B; the same is true of OWR( ). These functions may of course also be both “ordinary” one-way functions which are one-way for all parties, or one-way functions which employ public key cryptographic techniques (that is, encryption using the other entity's public key constitutes a one-way function from the point of view of an attacker who is not privy to the private key).
   To authenticate B to A, at authentication exchange i:
1. Entity A first calculates not a nonce value but instead either (a) selects the next MARV Ma from the list of MARVs for the authenticatee, or (b) constructs the MARV Ma by calculating the value OWM(kbᵢ).
2. Entity A sends this value to entity B.
3. Entity B verifies that this value is indeed either, as appropriate, (a) MARV Ma from its list, or (b) MARV Ma=OWM(kbᵢ). B can do because it knows, as appropriate, either the MARVs in its list or kbᵢ. If this verification fails, as it would if an attacker were attempting to supply false values, then B refuses to continue the authentication process and may signal a warning or error.
4. If this verification succeeds, then B combines this value, Ma, with its current password, kbᵢ: C(Ma,kbᵢ). In shorthand notation, this combined value may be notated simply as value “C”.
5. Entity B then applies the one-way function OWR( ) to value C to produce a Return value, R. Thus: R=OWR(C). As noted, the function OWR( ) may be the same as OWM( ), or it may differ; it may also be an application of public key cryptography using A's public key: E(KA_{pub}, C)
6. B returns this value R to A.
7. Entity A, at any time, performs the same calculation, which it can do because it knows, as appropriate, either the authenticatee's MARV or kbᵢ, and upon receipt of the return value R from B compares the result of this calculation with the value so received. If the values match, authentication succeeds; if they do not, authentication fails.

To authenticate A to B, the corresponding opposite process occurs. This may happen simultaneously or at a later point, but must happen before B again attempts to authenticate itself to A.

A and B should each increment their index i at any point during this authentication exchange after which they have no further need for the present value of i. If only the first “way” of the exchange is to occur, then this should occur after step 6 for B, and after step 7 for A. If both “ways” of the exchange are to occur, then this should occur at these steps in the second “way” of the exchange (e.g., after the first “way” where B has been authenticated to A, and during the second “way” where A is being authenticated to B).

Of course, this approach may also be used for one-way authentication of A to B or B to A simply by omitting systematically the other authentication.

The creation of MARVs in this approach may also be mixed such that MARVs used for each “way” of the authentication, independently of the other “way,” use stored MARV lists, MARVs created from the authenticatee's password list, or, as described below, MARVs generated from Lamport-style lists or from Lamport-style password lists. Those skilled in the art will have no difficulty in implementing these and other straightforward permutations of these methods as appropriate for particular operational situations.

As a variation on this method, instead of using a simple one-way function to secure the return value, B may use Public Key Cryptographic techniques, encrypting the return value using A's public key (assuming that A has generated a public/private keypair and published its public key). The advantage of this variation is that it allows A to extract both Ma and the B's (proposed) key value independently of each other. A may then determine not simply that authentication fails, but that an attacker is supplying B with false MARVs.

Two-Way Authentication Using Generated One-Time Password Lists Without Nonces

The information maintained by A and B in this method is the same as the information maintained in the “Two-Way Authentication Using Generated One-Time Password Lists with Nonces” with the following exceptions:
1. Neither A nor B need contain the capability of generating nonce values,
2. Both A and B use one-way functions in three roles. One of these roles will be performed by functions designated OWM( ), as discussed above, and will be used to produce Mutual. Anti-Replay Values (MARVs). Another of these roles will be performed by functions designated OWR( ), and will be used in the return of values from the authenticatee to the authenticator. Another of these roles will be performed by functions designated OWG( ), and will be used in the generation of password or key lists according to Lamport's method and, if they are generated independently, of the lists used to create MARVs. As discussed above, OWM( ) and OWR( ) may be identical or different in each of the two entities A and B; the same is true of OWG( ). Moreover, if MARVs lists are generated independently, the function OWG( ) as used for an entity's password list may be identical to or different from the function OWG( ) as used for its MARV list. These functions may of course also be “ordinary” one-way functions which are one-way for all parties, or one-way functions which employ public key cryptographic techniques (that is, encryption using the other entity's public key constitutes a one-way function from the point of view of an attacker who is not privy to the private key).
   To authenticate B to A, at authentication exchange i:
1. Entity A first calculates not a nonce value but instead the MARV Ma. It does so by applying the function OWM( ) either (a) to its most recent value in a Lamport-style generated list used for MARVs, such that for the authentication exchange i using list mb the authenticator knows mbᵢ₊₁ and thus Ma=OWM(mbᵢ₊₁), or (b) to the current value in the authenticatee's password list, such that for authentication exchange i using password list kb the authenticator knows kbᵢ₊₁ and thus Ma=OWM(kbᵢ₊₁).
2. Entity A sends this value to entity B.
3. Entity B computes, as appropriate, either (a) the current-plus-one value in its MARV-generating list, mbᵢ₊₁, by repeated application of the function OWG( ) for MARV lists to the seed value of this list, m, starting with OWG(m) according to Lamport's method, or (b) the current-plus-one key in its password list, kbᵢ₊₁, by repeated application of the function. OWG( ) for password lists to the seed value of this list, k, starting with OWG(k) according to Lamport's method. If the implementation of B stores intermediate values of the list, computation may, if appropriate, start with one of these values.
4. B computes the MARV that it expects to receive, either (a) Ma=OVM(mbᵢ₊₁) or (b) Ma=OVM(kbᵢ₊₁), as appropriate.
5. B verifies that Ma as received is equal to Ma as computed. If this verification fails, as it would if an attacker were attempting to supply false values, then B refuses to continue the authentication process and may signal a warning or error.
6. If authentication is to continue, then B composes C=C(Ma,kbᵢ).
7. B encrypts this composite value C into a return value R using A's public key:
   R=E(PKA_{pub},C)
8. B returns R to A.
9. A decrypts R to extract C: C=D(PKAₚᵣᵢᵥ,R).
10. A decomposes C, extracting Ma and kbᵢ.
11. A may verify that Ma as returned is equal to Ma as sent. If this verification fails, as it would if an attacker were attempting a replay attack, then A refuses to continue the authentication process and may signal a warning or error.
12. If authentication is to continue, then A computes OWG(kbᵢ)=(purportedly) kbᵢ₊₁.
13. A compares this result, which is effectively what B proposes for kbᵢ₊₁, with the value of kbᵢ₊₁ which it knows. If the values match, authentication succeeds; if they do not, it does not.
14. If authentication succeeds, then A may discard kbᵢ₊₁. (Or A may keep it, but it is not further useful in this protocol.)
15. If authentication succeeds, then A replaces kbᵢ₊₁ with kbᵢ as the new kbᵢ₊₁.
16. Similarly, if authentication succeeds, then if a separately maintained list for generating MARVs is being used then A may discard mbᵢ₊₁. (Or A may keep it, but it is not further useful in this protocol.)
17. Similarly, if authentication succeeds, then if a separately maintained list for generating MARVs is being used then A replaces mbᵢ₊₁ with mbᵢ as the new mbᵢ₊₁.

To authenticate A to B, the corresponding opposite process occurs, This may happen simultaneously or at a later point, but must happen before B again attempts to authenticate itself to A.

A and B should each increment their index i at any point during this authentication exchange after which they have no further need for the present value of i. If only the first “way” of the exchange is to occur, then this should occur after step 6 for B, and after step 12 for A. If both “ways” of the exchange are to occur, then this should occur at these steps in the second “way” of the exchange (e.g., after the first “way” where B has been authenticated to A, and during the second “way” where A is being authenticated to B).

Of course, this approach may also be used for one-way authentication of A to B or B to A simply by omitting systematically the other authentication.

The creation of MARVs in this approach may also be mixed such that MARVs used for each “way” of the authentication, independently of the other “way,” use stored MARV lists (as described earlier), MARVs created from the authenticatee's password list (as described earlier), or MARVs generated from Lamport-style lists or from Lamport-style password lists (as described here). Those skilled in the art will have no difficulty in implementing these and other straightforward permutations of these methods as appropriate for particular operational situations.

Two-Way Authentication Using both Stored and Generated Password Lists Without Nonces

It is possible to combine the two methods described above such that authentication in one “way” or direction is done with one type of password list (that is, a stored password list or a generated password list) and authentication in the other “way” is done with the opposite type of password list. Sufficient and appropriate information must be maintained, of course, in each entity for each method. Those skilled in the art will have no difficulty in implementing this straightforward permutation of the method.

### CONCLUSIONS, RAMIFICATIONS, AND SCOPE

Advantages of Two-Way Authentication Using Stored and Generated Password Lists with Nonces Methods

The methods of using Stored Password Lists with Nonces and Generated Password Lists with Nonces are novel, to the best of my knowledge, as they have not previously been applied in the art. However, these methods provide no advantages beyond the simple duplication of a known prior art method.

Advantages of Two-Way Authentication Using Stored Password Lists without Nonces

This method is novel, and provides a number of advantages, some of which themselves are novel.

Security Against Eavesdropping

As with all One-Time Password List methods, this method is secure against eavesdropping because the passwords are never re-used.

Tamper-Evidence at the Authenticator

As with all One-Time Password List methods, this method provides the possibility of tamper-evidence at the authenticator in the case of a replay attack (successful or unsuccessful) if a legitimate authentication attempt is made.

Security Against Replay Attacks

Because this method employs an Anti-Replay Value (here a non-nonce ARV, more specifically a MARV, in a role similar to that of the nonce value used in some prior art methods), it is secure against replay attacks. The contents of each authentication exchange depend upon the ARV used in that exchange, and because of the characteristics of this value the attacker cannot know future values of it and thus cannot cause the authenticatee to release to it valid authentication replies.

Combinations of Advantages

This method provides advantages in combinations not present in the prior art. In particular, while the “nonce methods” of the prior art provides security against replay attacks, but do not provide tamper-evidence at the authenticator, and while Lamport-style One-Time Password List methods provide the second of these advantages but not the first, this method provides both.

Tamper-Evidence at the Authenticatee in Real-Time

Those prior art methods which provide tamper-evidence in the case of replay attacks do so at the authenticator and do so only if a valid authentication is attempted in the future. This method not only provides this (as discussed above) but also provides tamper-evidence at the authenticatee while a replay attack is underway.

The flaw in prior art methods in this regard is that the authenticatee cannot know a priori what the nonce values are. It has no way of distinguishing valid nonce values supplied by A from attacking nonce values supplied by an attacker. It must respond equivalently to each.

In the method of this invention, the authenticatee can determine what the anti-replay value supplied to it should be, and therefore can refuse to participate in a (presumed) replay attack, and can be implemented so as to raise alarms in such an event. This requires a mutually known anti-replay value (MARV) and cannot be accomplished with prior art nonce methods.

Independence of Nonce Generation Flaws

The generation of nonce values can be difficult. If a flaw is discovered in the method used by an authenticator to generate nonce values, an attacker could more easily duplicate the behavior of the authenticator and successfully execute replay attacks (and more easily execute Man in the Middle attacks). Since the method of this invention does not use nonce values, it is not dependent upon the absence of any such flaws.

Security Against Known-Plaintext-Nonce Attacks

Many cryptographic functions, including functions used as one-way functions, are subject to cryptographic attacks which are much easier if the attacker can supply to the function known plaintext. Methods in which an authenticatee receives and must act upon a nonce value are subject to known-plaintext attacks because they cannot a priori distinguish legitimate from attacking nonce values.

However, the MARVs used in the method of this invention are not “nonce” values because they are related integrally to the secret password lists ka and kb (or are separate lists stored using similar methods). Because of this, each entity A or B can determine, without exposing any information on the communication channel, whether the MARV is valid. This secures this approach against known-plaintext attacks against its cryptographic algorithms.

Security Against (and Tamper-Evidence of) Serial Impersonation Attacks:

This method provides tamper-evidence of “serial impersonation” attacks against two-way authentication, with the same capabilities and for the same reasons as described in the sections on Two-Way Authentication using Store (and Generated) Password Lists with Nonces.

Further, this method provides for the detection of such “serial impersonation” attacks as they occur. No prior art method does this, and no known simple duplication of any one-way-only authentication method can do this.

In a “serial impersonation” attack on two-way authentication, the first “way” of authentication is allowed by the attacker to complete successfully. If in this first “way” A is the authenticator and B the authenticatee, then B is authenticated to A:
A<-B

The attacker then impersonates B, and attempts to ignore the following authentication step whereby A is authenticated to B:
A->Attacker-as-B(ignored)

In methods which depend upon nonce values, the ignoring of this “way” or round of authentication by the attacker may succeed, because A requires no information unique to B in order to proceed. (That is, B generates a nonce and passes it to A, who processes it and hands the results back to B.)

In the method of the present invention, no such nonce value is used. Instead, to complete this round B must pass to A a Mutual Anti-Replay Value generated from the password list for A. This MARV may then be checked by A, who has independent knowledge of it. The attacker, however, has no knowledge of the internal information in B, and thus cannot generate this value. In the case of such an attack, A will detect any attempted value supplied in place of this MARV and may be implemented so as to terminate the authentication at that point and/or raise an alarm based on this detection.

Quality of Passwords

Because this method uses stored password lists, the passwords so stored may be generated using methods up to and including the best practices and/or technologies then known. For example, they may be random numbers generated from physical, astronomical, and/or quantum mechanical sources.

Advantages of Two-Way Authentication Using Generated Password Lists without Nonces

The method of Two-Way Authentication Using Generated Password Lists without Nonces, described here, has all of the advantages of the corresponding method using Stored Password Lists, except for the following differences.

Reduced Storage

This method, as with Lamport's method when compared to Stored Password Lists, requires less storage. This is an advantage, of course.

Increased Computation

This method, as with Lamport's method when compared to Stored Password Lists, requires additional computation at the time of authentication. This is a disadvantage.

Reliance upon One-Way Functions

This method, as with Lamport's method when compared to Stored Password Lists, relies upon the quality of the one-way function used to generate the password lists. If a flaw in the one-way function used is discovered, implementations of this method using that function may be at risk.

Quality of Passwords

Because this method does not store password lists (or lists for MARVs), but rather generates them, the use of arbitrarily good practices or technologies in generating password or key values applies only to the initial keys ka and kb. This is in general true of any method using prearranged passwords, and so is not specifically an advantage of this method.

Disadvantages of Both Methods

Man in the Middle Attacks

All of the novel methods disclosed here are subject to single or repeated Man in the Middle attacks.

Password List Exhaustion

The password lists used in the Password List methods cited from the prior art and disclosed here as novel are finite, and so these methods are appropriate only for situations where a finite number of authentications are sufficient. Many such situations exist.

### REFERENCES

Anon. “The Book of Judges.” The Bible.
Bellovin, Steven M. and Michael Merritt. “An Attack on the Interlock Protocol When Used for Authentication.” IEEE Transactions on Information Theory. v. 40, n. 1 (January 1994): 273-275 and (1993 version) http://www.cs.columbia.edu/˜smb/papers/
Davies, D. W. and W. L. Price. Security for Computer Networks. NY: John Wiley & Sons, 1989.
de Raadt, Theo. et. al. OpenSSH. http://www.openssh.com/
Dierks, T. “The TLS Protocol.” RFC 2246. 1999.
Dierks, T. “The Transport Layer Security (TLS) Protocol, Version 1.1. RFC 4346. 2006.
Diffie, Whitfield and Martin Hellmann. “New Directions in Cryptography.” IEEE Transactions on Information Theory. Vol. IT-22, No. 6 (November 1976): 644-654.
Evans Jr., Arthur, William Kantrowitz, and Edwin Weiss. “A User Authentication Scheme Not Requiring Secrecy in the Computer.” Communications of the ACM. Vol. 17, No. 8 (August 1974): 437-442.
Franks, J., et. al. HTTP Authentication: Basic and Digest Access Authentication. RFC 2617. 1999.
Freier, Alan O., Philip Karlton, and Paul C. Kocher. “The SSL Protocol, Version 3.0.” Netscape Communications Corporation. http://wp.netscape.com/eng/ssl3/draft302.txt
Garrett, Paul. Making and Breaking Codes: An Introduction to Cryptology. Upper Saddle River, N.J.: Prentice-Hall, 2001.
Haller, N. “The S/KEY One-Time Password System.” RFC 1760. 1995.
Kaufmann, Charles W. “Method and Apparatus for Cryptograhic Authentication.” U.S. Pat. No. 5,666,415. Sep. 9, 1997.
Kohl, J. and C. Neuman. “The Kerberos Network Authentication Service (V5).” RFC 1510 (1993);
Lamport, L. “Password Authentication with Insecure Communication.” Communications of the ACM. 24.11 (November 1981): 770-772.
Miller, S. P., B. C. Neuman, J. I. Schiller, J. H. Saltzer. “Section E.2.1: Kerberos Authentication and Authorization System.” MIT Project Athena, December 1987. ftp://athena-dist.mit.edu/pub/kerberos/doc/techplan.txt
Needham, R. M. and M. D. Schroeder. “Using Encryption for Authentication in Large Networks of Computers.” Communications of the ACM. Vol. 21, No. 12 (December, 1978): 993-999.
Neuman, C., T. Yu, S. Hartman, K. Raeburn. “The Kerberos Network Authentication Service (V5).” RFC 4120. 2005.
Purdy, George. “Security Code.” University of Illinois, Center for Advanced Computation, 1973.
Rivest, Ronald L. and Adi Shamir. “How to Expose an Eavesdropper.” Communications of the ACM. Vol. 27, No. 4 (April 1984): 393-395.
Schneier, Bruce. Applied Cryptography. Second Edition. NY: John Wiley and Sons, 1996.
Shimizu, Akihiro. “Qualification Authentication Method using Variable Authentication Information.” US Patent Application 20020091932. Jul. 11, 2002.
Wilkes, Maurice V. Time-Sharing Computer Systems. NY: American Elsevier, 1972.
Ylonen, Tatu and Chris Lonvick (ed.) “The Secure Shell (SSH) Protocol Architecture.” RFC 4251.2006.

I claim:

1. A method and apparatus whereby two entities may authenticate each to the other comprising
(a) a list of arbitrary length of key data serving as the keys for one of the entities, maintained in the storage of that entity and also maintained in the storage of the other entity,
(b) optionally, a list of arbitrary length of data serving as values to be known as mutual anti-replay values, maintained in the storage of that entity and also maintained in the storage of the other entity,
(c) a list of arbitrary length of key data serving as the keys for the other of the entities, maintained in the storage of that entity and also maintained in the storage of the first entity,
(d) optionally, a list of arbitrary length of data serving as values to be known as mutual anti-replay values, maintained in the storage of the other of the entities and also maintained in the storage of the first entity,
(e) indexes into these key lists maintained by each entity,
(f) optionally, if independent lists of mutual anti-replay values are maintained, indexes into these lists of mutual anti-replay values,
(g) optionally, if independent lists of mutual anti-replay values are not maintained, a pair of one-way computational functions which may be applied to the contents of the key lists each of which functions is computationally feasible but the inverse of which is computationally infeasible for an attacker, such that each function of the pair may be identical to or different from the other, to be used to generate values to be known as mutual anti-replay values in lieu of separate lists of such values,
(h) another pair of one-way computational functions which may be applied to the contents of these lists each of which is computationally feasible but the inverse of which is computationally infeasible for an attacker, such that each function of the pair may be identical to or different from the other, to be used to generate values to be known as return values,
(i) a compositing computational function which may be used to combine key and other values in such a way that the inverse of this combination may easily be computed,
such that for one entity, in the role of authenticatee, to be authenticated to the other entity, in the role of authenticator,
(a) if a separate list of mutual anti-replay values is maintained, the authenticator selects the current value from the list of mutual anti-replay values for the authenticatee, or
(b) if a separate list of mutual anti-replay values is not maintained, the authenticator applies one of the mutual anti-replay value generating one-way functions to the current key in the authenticatee's list of keys, generating a value known as the mutual anti-replay value,
(c) the authenticator, at this or any point up to the receipt of authentication data back from the authenticatee, computes the application of the composition function to the mutual anti-replay value so generated and the current key in the authenticatee's list, and then computes the application of one of the return-value generating functions to this composition, using the return-value generating function to be used by the authenticatee in generating a return value in (i) below,
(d) the authenticator transmits the mutual anti-replay value to the authenticatee,
(e) if separate lists of mutual anti-replay values is maintained, the authenticatee selects the current value from its list, or
(f) if a separate list of mutual anti-replay values is not maintained, the authenticatee applies the mutual anti-replay value one-way function to the current key in its list of keys, generating a value which would in the absence of attacks or operational difficulties be identical to the anti-replay value it has received from the authenticator,
(g) the authenticatee compares the mutual anti-replay value as received at (d) with either the value so selected at (e) or the value so computed in (f) and, if they are identical, continues, but, if they differ, aborts the authentication protocol and optionally signals an error condition or warning alarm,
(h) if the authentication protocol is to continue, then the authenticatee computes the combination of this anti-replay value so received with the current key in its list of keys, using the same composition function used in (c) above by the authenticator,
(i) the authenticatee computes the application of one the same return-value generating one-way function used by the authenticator in (c) above by the authenticator to this composite value,
(j) the authenticatee transmits this result, called the return value, to the authenticator,
(k) the authenticator compares this value with the presumably identical value that it has previously computed,
(l) and if these two values match, then the authenticator concludes that the authentication of the authenticatee has occurred,
(m) this protocol is executed again, either simultaneously, interleaved, or serially, with the roles of authenticator and authenticatee reversed between the entities, to accomplish this second direction of authentication,
(n) the authenticator and authenticatee increment their indexes into the key lists at such points in the protocol after which these indexes are no longer required for the current exchange in either direction of authentication.

2. The method and apparatus of claim 1 where the authenticatee does not use an ordinary one-way function to generate the return value but instead uses public key cryptographic methods to generate the return value, such that
(a) the authenticator initially generates and maintains a public and a private key pair using public key cryptographic technology
(b) the authenticator makes known its public key to the authenticatee,
(c) the authenticatee encrypts its return value to the authenticator using this public key encryption technology and the authenticator's public key,
(d) the authenticator, on receipt of this return value, decrypts it using this public key encryption technology and its private key, and
(e) the authenticator decomposes the value so decrypted into its mutual anti-replay value and key components, and
(f) the authenticator, in addition to checking for the validity of the key either explicitly here or as described above, further checks the mutual anti-replay value as returned, and
(g) if the mutual anti-replay value is not identical to the value sent to B, the authenticator refuses to continue the authentication process and may signal an error or warning.

3. The method and apparatus of claim 1 wherein the authentication process is terminated at or ignored beyond the first authentication of one entity to the other, provided that
(a) the authenticator and authenticatee increment their indexes into the key lists at such points in the protocol after which these indexes are no longer required for the current exchange.

4. The method and apparatus of claim 2 wherein the authentication process is terminated at or ignored beyond the first authentication of one entity to the other, provide that
(a) the authenticator and authenticatee increment their indexes into the key lists at such points in the protocol after which these indexes are no longer required for the current exchange.

5. A method and apparatus whereby two entities may authenticate each to the other, comprising
(a) an initial key value for one of the entities, stored in that entity only,
(b) optionally, an initial mutual anti-replay list seed value, stored in that entity only,
(c) the current-plus-one key value for one of the entities, stored in the other entity only,
(d) optionally, the current-plus-one mutual anti-replay list value, stored in the other entity only,
(e) an initial key value for the other of the entities, stored in that entity only,
(f) optionally, an initial mutual anti-reply list seed value for the other of the entities, stored in that entity only,
(g) the current-plus-one key value for the other of the entities, stored in the first entity only,
(h) optionally, the current-plus-one mutual anti-replay list value for the other of the entities, stored in that entity only,
(i) a count or index for each entity representing the serial number of the current authentication exchange, stored respectively in each entity,
(j) in each entity, a one-way computational function which may be applied the initial key value from (a) and (e) above, and to subsequent recursive applications of this function, which is computationally feasible but the inverse of which is computationally infeasible, which function may be identical in both entities or different in each, used for the generation of key lists,
(k) optionally, in each entity, a one-way computational function which may be applied to the seed mutual anti-replay list value from (b) and (f) above, and to subsequent recursive applications of this function, which is computationally feasible but the inverse of which is computationally infeasible, which function may be identical in both entities or different in each, used for the generation of lists, if maintained separately, for the production of mutual anti-replay values,
(l) in each entity, a one-way computational function, different from the function identified in (j), if separate anti-replay value lists are not maintained, or (k), if separate anti-replay value lists are maintained, which may be applied to the values in (j) or (k) which is computationally feasible but the inverse of which is computationally infeasible, used for the generation of mutual anti-replay values either from generated key lists or, as appropriate, generated mutual anti-replay value lists,
(m) a public and private key pair for one of the entities, using any appropriate public-key cryptographic technology, the private key of which is stored in the entity and the public key of which is known at least to the other entity,
(n) a public and private key pair for the other of the entities, using any appropriate public-key cryptographic technology, the private key of which is stored in the entity and the public key of which is known at least to the other entity,
(o) in each entity, implementations of said appropriate public-key cryptographic technology,
(p) in each entity, a compositing computational function which may be used to combine key and other values in such a way that the inverse of this combination may easily be computed,
such that for one entity, in the role of authenticatee, to be authenticated to the other entity, in the role of authenticator,
(a) if a separate generated list for mutual anti-replay values is maintained, the authenticator calculates a mutual anti-replay value by applying the second one-way function of (l), above, to the current list value for the authenticatee, or
(b) if a separate generated list of mutual anti-replay values is not maintained, the authenticator calculates an anti-replay value by applying the second one-way function of (l), above, to the current key value for the authenticatee,
(c) the authenticator transmits this mutual anti-replay value to the authenticatee,
(d) the authenticatee generates its current key value by repeated application of the one-way function of (j), above, to the initial key value, to the results of the application of that function to the initial key value, to the result of this in turn, and so on until the current index value of the authentication exchange has been reached,
(e) if a separate generated list for mutual anti-replay values is maintained, the authenticatee generates the current value in that list by repeated application of the one-way function of (k), above, to the initial seed value for this list, to the result of this in turn, and so on until the current index value of the mutual anti-replay value list has been reached,
(f) if a separate generated list for mutual anti-replay values is maintained, the authenticatee calculates the anti-replay value that it expects to receive by applying the one-way function of (l) to the current value in its mutual anti-replay value list as computed in (e), or
(g) if a separate generated list for mutual anti-replay value sis not maintained, the authenticatee calculates the anti-replay value that it expects to see by applying the one-way function of (l) to its current key value as computed in (d),
(h) if the anti-replay value as received does not match the expected anti-replay value as computed, then the authenticatee aborts the authentication process and optionally signals an error condition or warning alarm,
(i) if the anti-replay value as received does match the expected anti-replay value, then the authenticatee continues the authentication protocol,
(j) if the authentication protocol is to continue, then the authenticatee applies the composing computational function to compute the combination of this anti-replay value so received or expected with the current key as computed,
(k) the authenticatee then encrypts this combined value using a public key cryptographic technology and the public key of the authenticator,
(l) the authenticatee transmits this encrypted value to the authenticator,
(m) the authenticator decrypts this received encrypted value using a public key cryptographic technology and its own private key, extracting from this process the mutual anti-replay value and the current key for the authenticatee,
(n) the authenticator examines the mutual anti-replay value so extracted and compares it with the mutual anti-replay value sent, and if this value does not match the mutual anti-replay value as sent, then the authenticator aborts the authentication process and optionally signals an error condition or warning alarm,
(o) the authenticator applies the key generation one-way function of (j) to this current key value to obtain the current-plus-one key value in the authenticatee's list of keys,
(p) the authenticator compares this current-plus-one key value so computed from information received from the authenticatee against its stored version of the current-plus-one key value,
(q) if the key values so compared match, then the authentication succeeds
(r) if the key values so compared do not match, then the authentication fails,
(s) the authenticator may then discard the current-plus-one key value,
(t) if a separate generated mutual anti-replay value list is maintained, the authenticator may then discard the current-plus-one value of this list,
(u) the authenticator takes the current key value as received from the authenticatee to be the current-plus-one key value for the next authentication of the authenticatee,
(v) if a separate generated mutual anti-replay value list is maintained, the authenticator takes the current mutual anti-replay value as received from the authenticatee to be the current-plus-one mutual anti-replay value for the next authentication of the authenticatee,
(w) this protocol is executed again, either simultaneously, interleaved, or serially, with the roles of authenticator and authenticatee reversed between the entities, to accomplish the second direction of authentication.

6. The method and apparatus of claim 5 wherein the authentication process is terminated at or ignored beyond the first authentication of one entity to the other, provided that
(a) the authenticator and authenticatee increment their indexes into the key lists at such points in the protocol after which these indexes are no longer required for the current exchange.

7. The method and apparatus of claims 1, 2, and 5 wherein the authentication process proceeds in one direction between two entities as described in claims 1 or 2 and in the opposite direction between the same two entities as described in claim 5.
